(19) United States
(12) Patent Application Publication
(10) Pub. No.: US 2023/0196506 A1
(43) Pub. Date: Jun. 22, 2023

(54) IMAGE RESOLUTION ADJUSTMENT SYSTEM AND METHOD THEREOF

(71) Applicant: AIXlink Ltd., Chengdu City (CN)

(72) Inventor: Chih-Cheng LIN, Hsinchu City (TW)

(73) Assignee: AIXlink Ltd., Chengdu City (CN)

(21) Appl. No.: 18/070,479

(22) Filed: Nov. 29, 2022

Related U.S. Application Data
(60) Provisional application No. 63/291,452, filed on Dec. 19, 2021.

(51) Int. Cl. G06T 3/40; G06T 7/174; G06F 3/14; G06T 11/00; G01S 3/48

(52) U.S. Cl. CPC G06T 3/4007; G06T 7/174; G06F 3/1423; G06T 11/00; G01S 3/48; G06T 2210/36

(57) ABSTRACT

The present disclosure provides an image resolution adjustment system and a method thereof. The system comprises a transmitter and an image display device. The image display device presets a first resolution display screen. A wireless link is established between the image display device and the transmitter. The transmitter transmits a wireless signal. The image display device obtains the wireless signal from the transmitter. The image display device performs a position algorithm according to the wireless signal to calculate a relative position and perform the image adjustment for the first resolution display screen according to the relative position to generate a second resolution display image. So, the screen resolution of the image display device is adjusted according to the relative position such that users can have better visual effect and convenience.

### CROSS-REFERENCE TO RELATED APPLICATION

This application claims the priority benefit of U.S. Patent Application Ser. No. 63/291,452, filed on Dec. 19, 2021, the full disclosure of which is incorporated herein by reference.

### BACKGROUND

### Technical Field

The present disclosure relates to the technical field of image display, particularly to an image resolution adjustment system and method thereof.

### Related Art

At present, stereoscopic images are mainly based on the image difference between images seen by the left and right eyes. The image difference can be displayed by alternately displaying the images seen by the left and right eyes by means of time division to form a stereoscopic image in combination.

A stereoscopic image display method in the prior art includes a stereoscopic image display device and shutter glasses, where the stereoscopic image display device provides a stereoscopic image. When one wishes to watch the stereoscopic image, the shutter glasses should be worn. Then the odd images corresponding to the right eye are viewed through the right eye part of the shutter glasses and the even images corresponding to the left eye are viewed through the left eye portion of the shutter glasses. So, different images seen by the left and right eyes are combined into the stereoscopic image in the human brain.

Another stereoscopic image display method in prior arts includes polarized glasses. The stereoscopic image display device projects a horizontally polarized light image and a vertically polarized light image to form the stereoscopic image. When one wishes to experience the stereoscopic image, the polarized glasses should be worn to see images with differently polarized light through the left and right eye parts of the polarized glasses as those images are combined into the stereoscopic image.

Moreover, another stereoscopic image display method in the prior art is mainly to dispose a cylindrical prism in the stereoscopic image display device to split an image into left and right images directly for the left and right eyes respectively, for the stereoscopic image experience such that the user can directly watch in the form of naked vision, so as to form the stereoscopic image.

However, in the prior art, there are disadvantages of the stereoscopic image display methods described above: the shutter glasses need to be charged frequently; the polarized glasses would reduce the brightness of the stereoscopic image as seeing polarized light; when seeing the cylindrical prism at a certain angle, the cylindrical prism will distort the image.

Thus, an improved solution for the prior arts is essential.

### SUMMARY

The embodiments of the present disclosure provide an image resolution adjustment system and method thereof to adjust the image resolution of the image display device based on a relationship between a user's position and an image display device such that users can experience excellent visual effects and convenience.

For achieving the above purpose, an image resolution adjustment system is provided, which comprises:

a transmitter transmitting a wireless signal; and
an image display device presetting a first resolution display screen; a wireless link is established between the image display device and the transmitter; the image display device obtains the wireless signal from the transmitter;
wherein, the image display device performs a position algorithm according to the wireless signal to calculate a relative position and matches the first resolution display screen according to the relative position to generate a second resolution display screen matching the relative position.

Preferably, the image display device performs an image adjustment for the first resolution display screen according to the relative position to generate the second resolution display screen that matches the relative position.

Preferably, the image display device comprises:

a receiver, wherein a wireless link is established between the receiver and the transmitter; the receiver receives the wireless signal from the transmitter;
a display displaying the first resolution display screen and the second resolution display screen; and
a processor connected to the receiver and the display;
wherein, the processor performs an image segmentation for the first resolution display screen to generate a plurality of block images; the plurality of block images respectively correspond to and match the relative positions; the processor calculates the relative positions according to the wireless signal and performs the image adjustment for the plurality of block images of the first resolution display screen according to the relative positions to generate the second resolution display screen.

Preferably, the receiver comprises:

a first antenna receiving the wireless signal from the transmitter; and
a second antenna, wherein an antenna distance exists between the second antenna and the first antenna; the second antenna receives the wireless signal from the transmitter.

Preferably, the processor is connected to the first antenna and the second antenna; when the first antenna and the second antenna respectively receive the wireless signals, a first angle and a second angle are calculated according to the received wireless signals and the antenna distance; an angular phase difference information is calculated according to the first angle and the second angle; the relative position is calculated according to the angular phase difference information and a coordinate information of the image display device.

Preferably, the image adjustment is an image interpolation method.

With the above configuration, the image display device could receive the wireless signal from the transmitter and could perform the position algorithm according to the wireless signal to calculate the relative position. The image display device performs the image adjustment for the first resolution display screen according to the relative position to adjust the screen resolution of the image display device to generate the second resolution display screen for excellent visual effects and convenience.

For achieving the above purpose, an image resolution adjustment method is also provided, applied to an image resolution adjustment system comprising a transmitter and an image display device, wherein a wireless link is established between the transmitter and the image display device; wherein the image resolution adjustment method performed by the image display device comprises the following steps:

presetting a first resolution display screen;
receiving a wireless signal from the transmitter;
performing a position algorithm according to the wireless signal to calculate a relative position; and
matching the first resolution display screen according to the relative position to generate a second resolution display screen matching the relative position.

Preferably, the step of “performing a position algorithm according to the wireless signal to calculate a relative position” comprises the following sub-steps:

calculating a first angle and a second angle according to a coordinate information of the image display device, the wireless signal received by a first antenna and a second antenna, and an antenna distance between the first antenna and the second antenna;
calculating an angular phase difference information according to the first angle and the second angle; and
calculating the relative position according to the coordinate information and the angular phase difference information.

Preferably, the step of “matching the first resolution display screen according to the relative position to generate a second resolution display screen matching the relative position” comprises the following sub-step:

performing an image adjustment for the first resolution display screen according to the relative position to generate the second resolution display screen that matches the relative position.

Preferably, the step of “performing an image adjustment for the first resolution display screen according to the relative position to generate the second resolution display screen that matches the relative position” comprises the following sub-steps:

performing an image segmentation for the first resolution display screen to generate a plurality of block images;
matching the plurality of block images with the relative positions respectively; and
performing the image adjustment for the plurality of block images of the first resolution display screen according to the relative positions to generate the second resolution display screen that matches the relative position.

With the above methods, the image display device could receive the wireless signal from the transmitter and could perform the position algorithm according to the wireless signal to calculate the relative position. The image display device performs the image adjustment for the first resolution display screen according to the relative position to adjust the screen resolution of the image display device to generate the second resolution display screen for excellent visual effects and convenience.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a block diagram of an image resolution adjustment system of the present disclosure;

FIG. 2 is another block diagram of the image resolution adjustment system of the present disclosure;

FIG. 3 is yet another block diagram of the image resolution adjustment system of the present disclosure;

FIG. 4 is an application scenario diagram of the image resolution adjustment system of the present disclosure;

FIG. 5 is a schematic diagram of an interpolation method of an image adjustment method;

FIG. 6 is a flowchart of the image resolution adjustment method of the present disclosure;

FIG. 7 is another flowchart of the image resolution adjustment method of the present disclosure;

FIG. 8 is yet another flowchart of the image resolution adjustment method of the present disclosure; and

FIG. 9 is yet another flowchart of the image resolution adjustment method of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

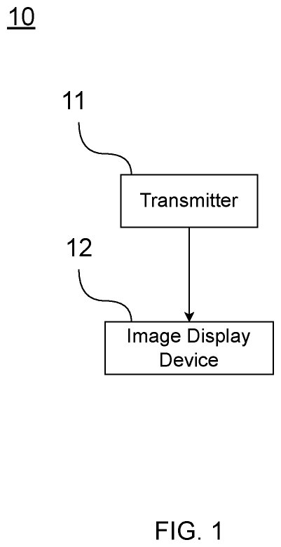

As shown in FIG. 1, in a preferable embodiment of an image resolution adjustment system 10 of the present disclosure, the image resolution adjustment system 10 comprises a transmitter 11 and an image display device 12. A wireless link is established between the transmitter 11 and the image display device 12. The transmitter 11 transmits a wireless signal to the image display device 12 through the wireless link. The image display device 12 presets a first resolution display screen. The image display device 12 performs a position algorithm according to the wireless signal to calculate a relative position and matches the first resolution display screen according to the relative position to generate a second resolution display screen that matches the relative position. In this embodiment, the wireless signal could be a Bluetooth signal, an ultra-wideband (UWB) signal, or an infrared (IR) signal.

Specifically, when the image display device 12 obtains the wireless signal from the transmitter 11, the relative position between the transmitter 11 and the image display device 12 can be calculated according to the wireless signal to match the first resolution display screen according to the relative position, to generate the second resolution display screen that matches the relative position.

In this embodiment, the image display device 12 performs an image adjustment for the first resolution display screen according to the relative position to generate the second resolution display screen that matches the relative position.

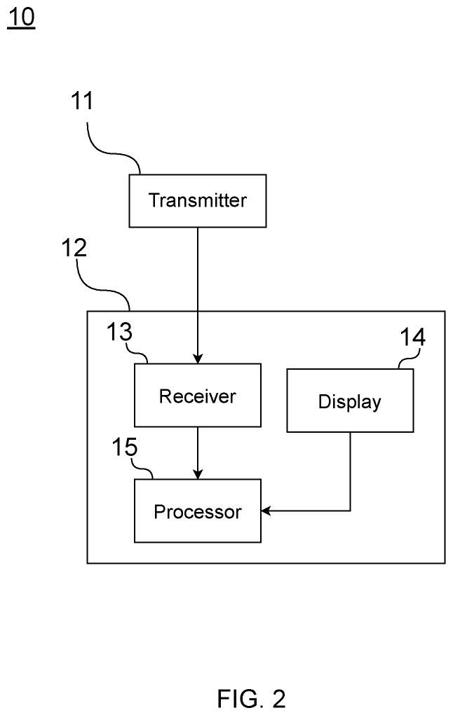

In this embodiment, as shown in FIG. 2, the image display device 12 comprises a receiver 13, a display 14, and a processor 15. A wireless link is established between the receiver 13 and the transmitter 11. The receiver 13 receives the wireless signal from the transmitter 11. The display 14 displays the first resolution display screen and the second resolution display screen. The processor 15 is electrically connected to the receiver 13 and the display 14. The processor 15 performs an image segmentation process for the first resolution display screen to generate a plurality of block images, which correspond to and match the relative positions respectively. When the receiver 13 receives the wireless signal from the transmitter 11 and transmits the wireless signal to the processor 15, the processor 15 would calculate the relative position between the transmitter 11 and the receiver 13 according to the wireless signal. Then, the processor 15 performs the image adjustment for the plurality of block images of the first resolution display screen according to the relative position to generate the second resolution display screen.

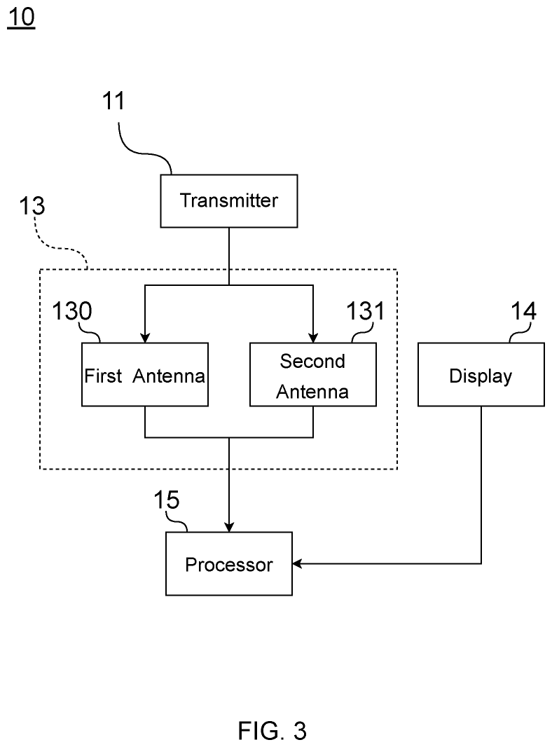

In this embodiment, as shown in FIG. 3, the receiver 13 has a first antenna 130 and a second antenna 131. An antenna distance (not shown) exists between the first antenna 130 and the second antenna 131. The receiver 13 receives the wireless signal from the transmitter 11 through the first antenna 130 and the second antenna 131. Then, the processor 15 calculates a first angle and a second angle according to the coordinate information of the image display device 12, the wireless signal received by the first antenna 130 and the second antenna 131, and the antenna distance and calculates an angular phase difference information according to the first angle and the second angle. According to the angular phase difference information and the coordinate information of the image display device 12, the processor 15 performs the position algorithm to calculate the relative position. In this embodiment, the position algorithm calculates the relative position based on an angle of arrival (AOA).

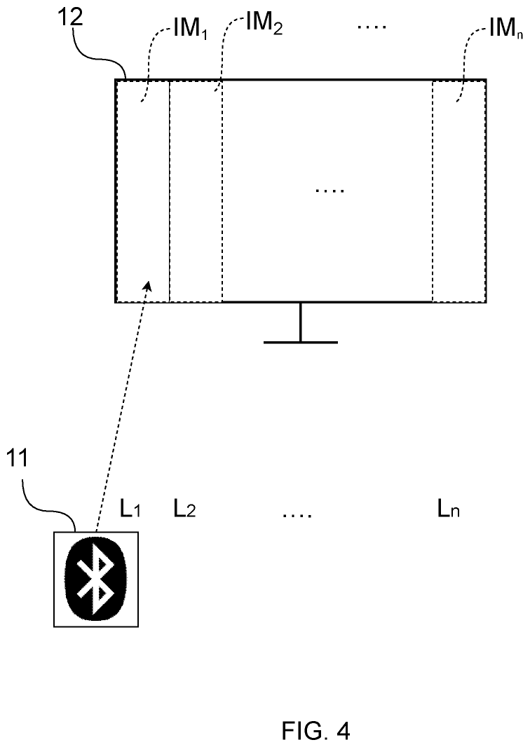

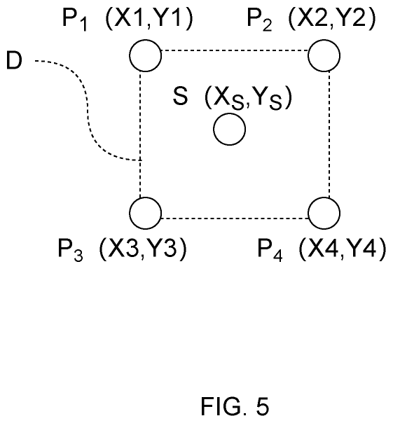

For example, as shown in FIG. 4 and FIG. 5, the receiver 13 receives the wireless signal from the transmitter 11 and transmits the wireless signal to the processor 15. The processor 15 calculates the relative position L₁, L₂ to Lₙ, wherein n≠0, between the transmitter 11 and the receiver 13 according to the wireless signal. The processor 15 determines the corresponding block image IM₁ according to the relative position L₁ and performs image interpolation for a plurality of pixels of the plurality of block images IM₁, IM₂ to IMₙ of the first resolution display screen according to the block image IM₁ corresponding to the relative position L₁ to generate the second resolution display screen. The image interpolation method is based on four pixels P₁, P₂, P₃, and P₄ and a supplementary pixel S in a display area D, where the coordinates of the four pixels are respectively (Xl, Y1), (X2, Y2), (X3, Y3) and (X4, Y4), and the coordinate of the supplementary pixels is (X_{S}, Y_{S}), according to which four distances can be obtained by calculation. According to the four distances, four weights can be determined correspondingly. Then, weighting can be performed respectively to obtain the supplementary pixels S based on the four weights and the corresponding four pixels P₁, P₂, P₃, and P₄.

When the preset first resolution display screen is based on n=9 and the resolution is 4096 pixels, the block images would be IM₁ to IM₉, and the relative positions would be L₁-L₉, where the block image IM₁ matches the relative position L₁, the block image IM₂ matches the relative position L₂, the block image IM₃ matches the relative position L₃, and the subsequent block images would match the relative positions respectively. The resolution of 4096 pixels is divided into two images for the left and right eye, so the resolutions are each 2048 pixels. Then, divide the 2048 pixels into 9 equal parts for 9 users to watch at the same time, wherein the pixels of the left and right images that can be viewed by each user are 227 pixels respectively. When the receiver 13 receives the wireless signal transmitted by the transmitter 11 and the number of the transmitters 11 is 4 (n=4) and the resolution is 4096 pixels, the block images would be and the relative positions would be L₁-L₄. The resolution of 4096 pixels is divided into two images for left and right eye, so the resolutions are each 2048 pixels. Then, divide the 2048 pixels into 4 equal parts for 4 users to watch at the same time, wherein the pixels of the left and right images that can be viewed by each user are 512 pixels respectively. Then, the supplementary pixel S between adjacent pixels is adjusted by the image adjustment to generate the second resolution display screen that matches the relative position.

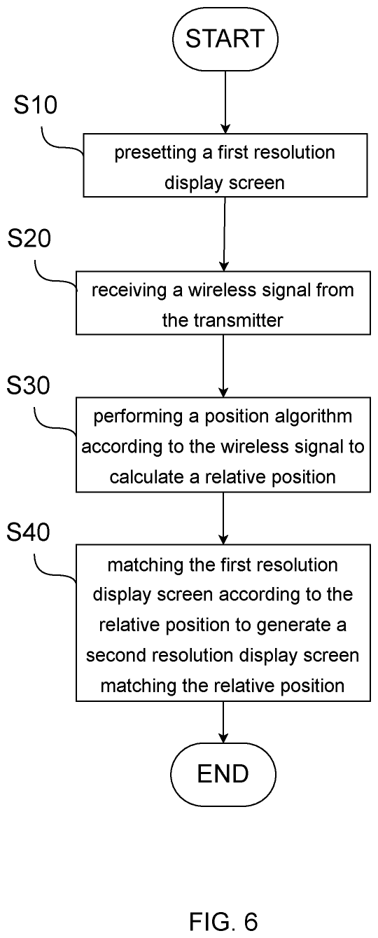

Besides, in a preferred embodiment of the image resolution adjustment method of the present disclosure, as shown in FIG. 6, an image resolution adjustment method is provided, which is applied to an image resolution adjustment system. The image resolution adjustment system comprises a transmitter and an image display device, wherein a wireless link is established between the transmitter and the image display device. Wherein the image resolution adjustment method performed by the image display device comprises the following steps:

presetting a first resolution display screen (S10);
receiving a wireless signal from the transmitter (S20);
performing a position algorithm according to the wireless signal to calculate a relative position (S30); and
matching the first resolution display screen according to the relative position to generate a second resolution display screen matching the relative position (S40).

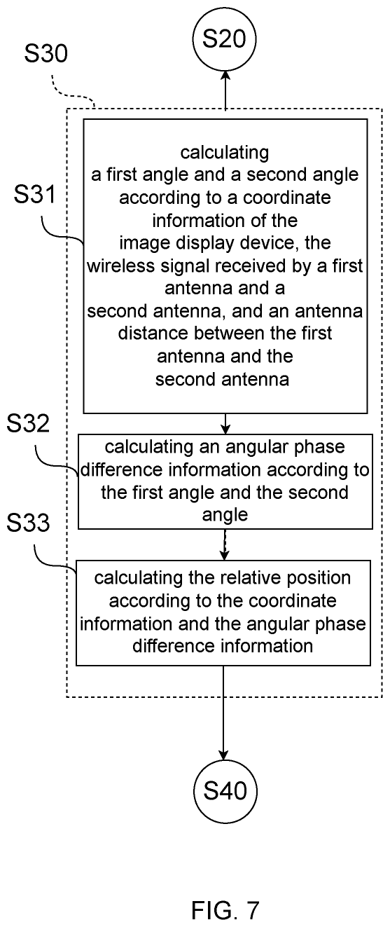

In this embodiment, as shown in FIG. 7, the step of “performing a position algorithm according to the wireless signal to calculate a relative position (S30)” comprises the following sub-steps:

calculating a first angle and a second angle according to a coordinate information of the image display device, the wireless signal received by a first antenna and a second antenna, and an antenna distance between the first antenna and the second antenna (S31);
calculating an angular phase difference information according to the first angle and the second angle (S32); and
calculating the relative position according to the coordinate information and the angular phase difference information (S33).

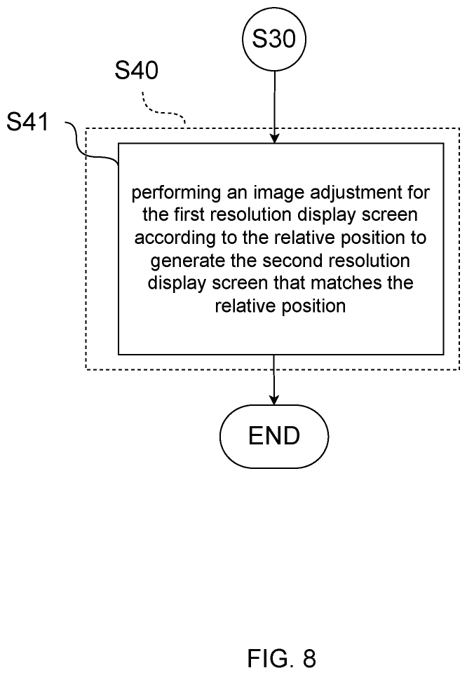

In this embodiment, as shown in FIG. 8, the step of “matching the first resolution display screen according to the relative position to generate a second resolution display screen matching the relative position (S40)” comprises the following sub-step:

performing an image adjustment for the first resolution display screen according to the relative position to generate the second resolution display screen that matches the relative position (S41).

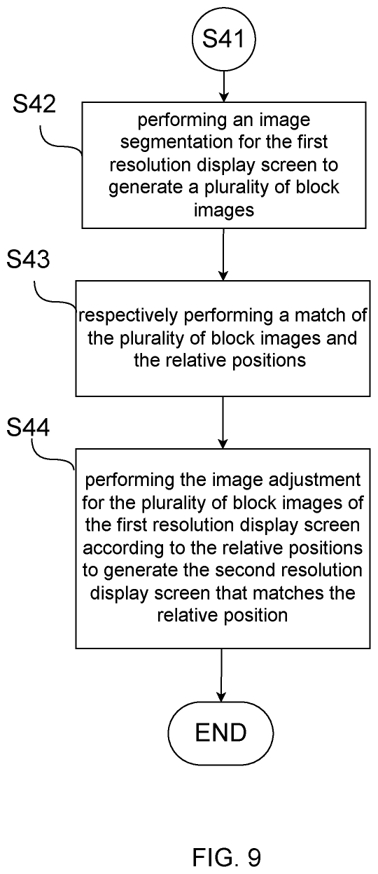

In this embodiment, as shown in FIG. 9, the step of “performing an image adjustment for the first resolution display screen according to the relative position to generate the second resolution display screen that matches the relative position (S41)” comprises the following sub-steps:

performing an image segmentation for the first resolution display screen to generate a plurality of block images (S42);
respectively performing a match of the plurality of block images and the relative positions (S43); and
performing the image adjustment for the plurality of block images of the first resolution display screen according to the relative positions to generate the second resolution display screen that matches the relative position (S44).

In summary, the image display device could receive the wireless signal from the transmitter and could perform the position algorithm according to the wireless signal to calculate the relative position. The image display device performs the image adjustment for the first resolution display screen according to the relative position to adjust the screen resolution of the image display device to generate the second resolution display screen for excellent visual effects and convenience.

It is to be understood that the term “comprises”, “comprising”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. An image resolution adjustment system, comprising:
a transmitter transmitting a wireless signal; and
an image display device presetting a first resolution display screen, a wireless link being established between the image display device and the transmitter, the image display device obtaining the wireless signal from the transmitter;
wherein, the image display device performs a position algorithm according to the wireless signal to calculate a relative position and matches the first resolution display screen according to the relative position to generate a second resolution display screen matching the relative position.

2. The image resolution adjustment system according to claim 1, wherein the image display device performs an image adjustment for the first resolution display screen according to the relative position to generate the second resolution display screen that matches the relative position.

3. The image resolution adjustment system according to claim 2, wherein the image display device comprises:
a receiver, wherein a wireless link is established between the receiver and the transmitter; the receiver receives the wireless signal from the transmitter;
a display displaying the first resolution display screen and the second resolution display screen; and
a processor connected to the receiver and the display;
wherein, the processor performs an image segmentation for the first resolution display screen to generate a plurality of block images; the plurality of block images respectively correspond to and match the relative positions;
the processor calculates the relative positions according to the wireless signal and performs the image adjustment for the plurality of block images of the first resolution display screen according to the relative positions to generate the second resolution display screen.

4. The image resolution adjustment system according to claim 3, wherein the receiver comprises:
a first antenna receiving the wireless signal from the transmitter; and
a second antenna, wherein an antenna distance exists between the second antenna and the first antenna; the second antenna receives the wireless signal from the transmitter.

5. The image resolution adjustment system according to claim 4, wherein the processor is connected to the first antenna and the second antenna; when the first antenna and the second antenna respectively receive the wireless signals, a first angle and a second angle are calculated according to the received wireless signals and the antenna distance; an angular phase difference information is calculated according to the first angle and the second angle; the relative position is calculated according to the angular phase difference information and a coordinate information of the image display device.

6. The image resolution adjustment system according to claim 5, wherein the image adjustment is an image interpolation method.

7. An image resolution adjustment method, applied to an image resolution adjustment system comprising a transmitter and an image display device, wherein a wireless link is established between the transmitter and the image display device; wherein the image resolution adjustment method performed by the image display device comprises the following steps:
presetting a first resolution display screen;
receiving a wireless signal from the transmitter;
performing a position algorithm according to the wireless signal to calculate a relative position; and
matching the first resolution display screen according to the relative position to generate a second resolution display screen matching the relative position.

8. The image resolution adjustment method according to claim 7, wherein the step of “performing a position algorithm according to the wireless signal to calculate a relative position” comprises the following sub-steps:
calculating a first angle and a second angle according to a coordinate information of the image display device, the wireless signal received by a first antenna and a second antenna, and an antenna distance between the first antenna and the second antenna;
calculating an angular phase difference information according to the first angle and the second angle; and
calculating the relative position according to the coordinate information and the angular phase difference information.

9. The image resolution adjustment method according to claim 7, wherein the step of “matching the first resolution display screen according to the relative position to generate a second resolution display screen matching the relative position” comprises the following sub-step:
performing an image adjustment for the first resolution display screen according to the relative position to generate the second resolution display screen that matches the relative position.

10. The image resolution adjustment method according to claim 9, wherein the step of “performing an image adjustment for the first resolution display screen according to the relative position to generate the second resolution display screen that matches the relative position” comprises the following sub-steps:
performing an image segmentation for the first resolution display screen to generate a plurality of block images;
matching the plurality of block images with the relative positions respectively; and
performing the image adjustment for the plurality of block images of the first resolution display screen according to the relative positions to generate the second resolution display screen that matches the relative position.
